(19) United States
(12) Patent Application Publication
(10) Pub. No.: US 2004/0124978 A1
(43) Pub. Date: Jul. 1, 2004

(54) Transmitter for a wireless security and alerting system with at least one discreet button for identification

(75) Inventor: Wen Chin Chen, Taipei (TW)

Correspondence Address: MARTINE & PENILLA, LLP, 710 LAKEWAY DRIVE, SUITE 170, SUNNYVALE, CA, 94085, US

(73) Assignee: IQ Group Sdn Bhd, Penang (MY)

(21) Appl. No.: 10/335,040

(22) Filed: Dec. 30, 2002

(51) Int. Cl. G08B 1/08

(52) U.S. Cl. 340/539.14

(57) ABSTRACT

A device to enable identification to a wireless security and alerting system which includes a transmitter circuit and a receiver circuit is provided. Each transmitter is provided with at least two buttons. A visitor uses a main push button. At least one discreet button is used discreetly by a member, such that the receiver will chime differently, thus allowing the residents within the hearing range to distinguish between a visitor from a member. The device also includes a low battery warning arrangement. An example allows a plurality of locations in a building to be equipped with such transmitters, which are connected to at least one receiver. An application-specific integrated circuit (ASIC) or the like device is employed in a transmitter circuit, and a microprocessor or the like device in a receiver circuit.

### TECHNICAL FIELD

The invention relates to a wireless security and alerting system which includes receivers receiving radio frequency transmissions from transmitters, each transmitter is operable with at least one button which is configured in a discreet arrangement. As such, the discreet button is only used by those familiar with the arrangement, hence allowing identification.

### BACKGROUND

Security systems are commonly known in which a plurality of transmitters is installed to doors and windows of a building, and audible indication or alarm signal is produced when any one of the doors or windows is compromised. A common alarm unit receives and decodes this signal. A unique alarm signal corresponding to this location is then sounded or displayed.

U.S. Pat. No. 5,365,214 discloses a musical wireless alerting system. Several detectors transmit radio frequency (RF) signals to a common receiver. The detectors include manual switches thereon to allow manual selection of a song or melody. The selection is coded in the form of an audio code which is transmitted to the receiver. The receiver detects any RF transmissions and verifies that the received transmissions are identifiable with the receiver. Upon verification, the receiver reads the audio code and compares it to a plurality of stored songs or tones within memory for transmission to a speaker which plays the song or tone. Each of the detectors may sense different predefined conditions and indicate different audible indications to be played. The detectors may sense conditions such as opening of the door or depression of a doorbell. The main disadvantage of the prior art invention is that the predefined conditions do not include personal identification. In other words, when a visitor or a member uses the same detector button, he/she is not differentiated.

### SUMMARY OF THE INVENTION

A primary object of the present invention is to allow identification of a person approaching a wireless security and alerting system which comprises at least a transmitter circuit and at least a receiver circuit. This primary object is achieved by providing each transmitter with at least two buttons. A visitor uses a main push button. At least one second button is camouflaged and is used as a discreet button by a member. When either button is activated, the receiver will be activated with different tunes which have been pre-selected by the installer, thus allowing the residents within the hearing range to distinguish between a visitor from a member.

Another object of the present invention is to allow a plurality of locations in a building to be equipped with such transmitters or receivers. This is achieved by incorporating an application-specific integrated circuit or the like device to the transmitter circuit, and a microprocessor or the like device to the receiver circuit.

### BRIEF DESCRIPTION OF THE DRAWINGS

In order that the present invention may be more readily understood, the following description is given, by way of example, of one preferred embodiment of each component making up a wireless security and alerting system with at least one discreet button for identification in accordance with the present invention. Reference is made to the accompanying drawings, in which:

FIG. 1a is a front view of one preferred embodiment of a two-button transmitter according to the invention;

FIG. 1b is a perspective view of the transmitter shown in FIG. 1a;

FIG. 1c is a staggered assembly view of the transmitter shown in FIG. 1a;

FIG. 2 shows one preferred embodiment of a transmitter circuit diagram according to the invention;

FIG. 3a shows a chime portion of one preferred embodiment of a receiver circuit diagram according to the invention; and

FIG. 3b shows a controller portion of the receiver circuit shown in FIG. 3a.

### DETAILED DESCRIPTION

According to the invention, a security and alerting system comprises essentially battery-operated transmitters in wireless communication with at least one receiver. The wireless communication is achieved through radio frequency signals. The receiver is connected either to a chime or a lighting means.

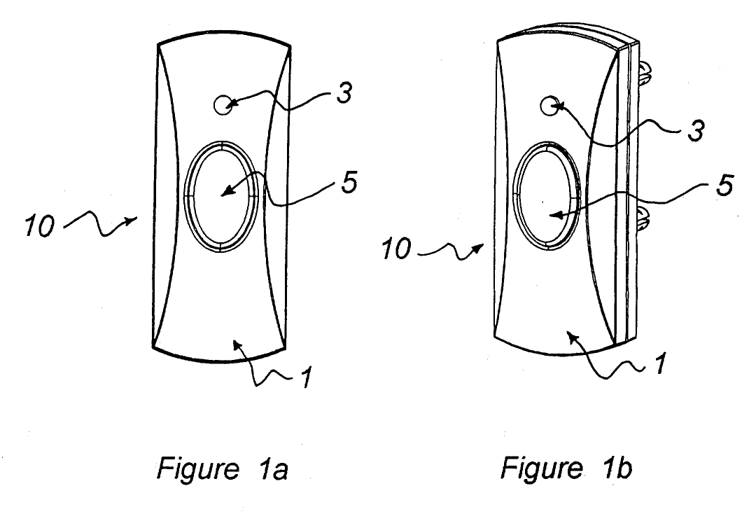

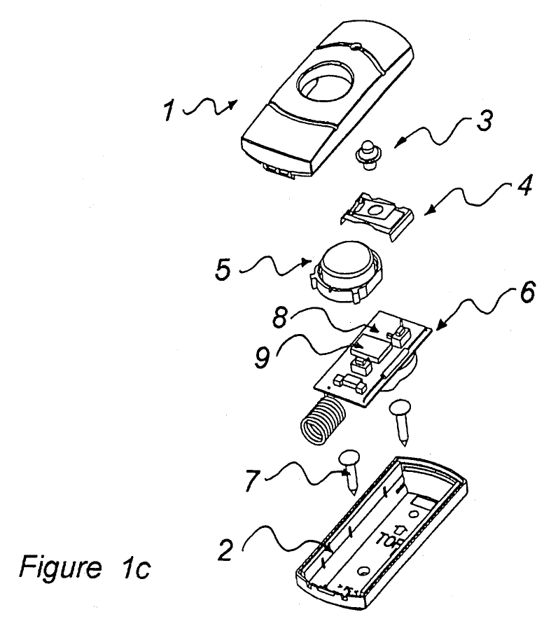

As seen in FIGS. 1a, 1b and 1c, two buttons are provided on one preferred embodiment of a transmitter (10). The transmitter (10) comprises essentially a cover (1) and a base (2). Screws (7) are employed to attach or mount the base (2) to a wall. The cover (1) and the base (2) include a printed circuit board assembly (6), which engages a main push button (5). The printed circuit board assembly (6) also includes an application-specific integrated circuit (9) and a LED (8). The LED (8), in turn, engages a light guide (3) and a spring-toggle switch (4). The spring-toggle switch (4) and the light guide (3) camouflage the LED (8) and allow it to be depressed as a discreet button (3), thus activating the printed circuit board assembly (6) accordingly. The main push button (5) and the discreet button (3) make up the two-button transmitter (10).

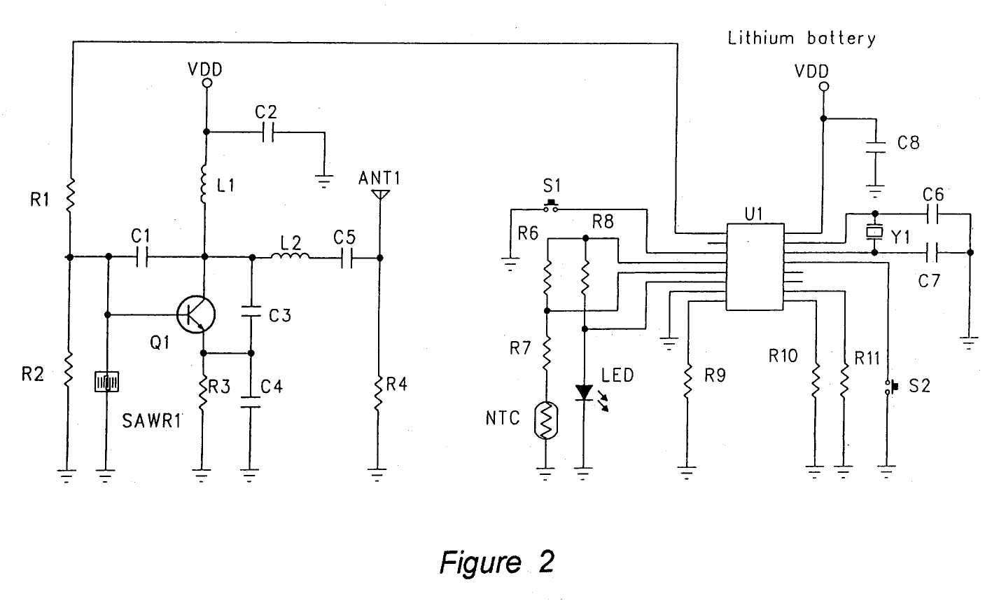

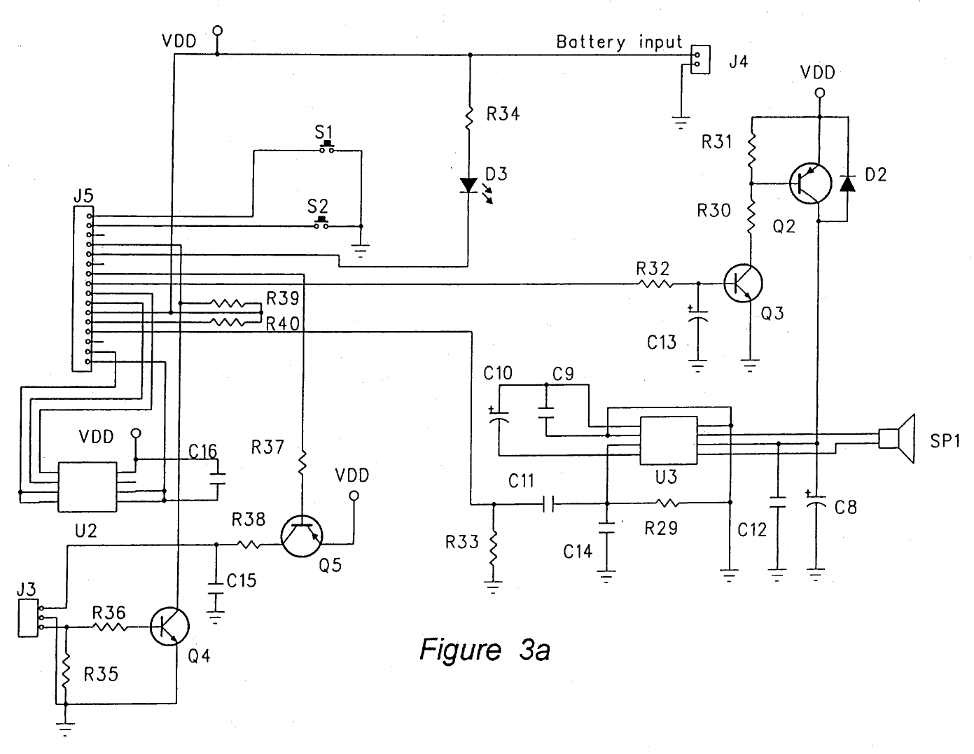

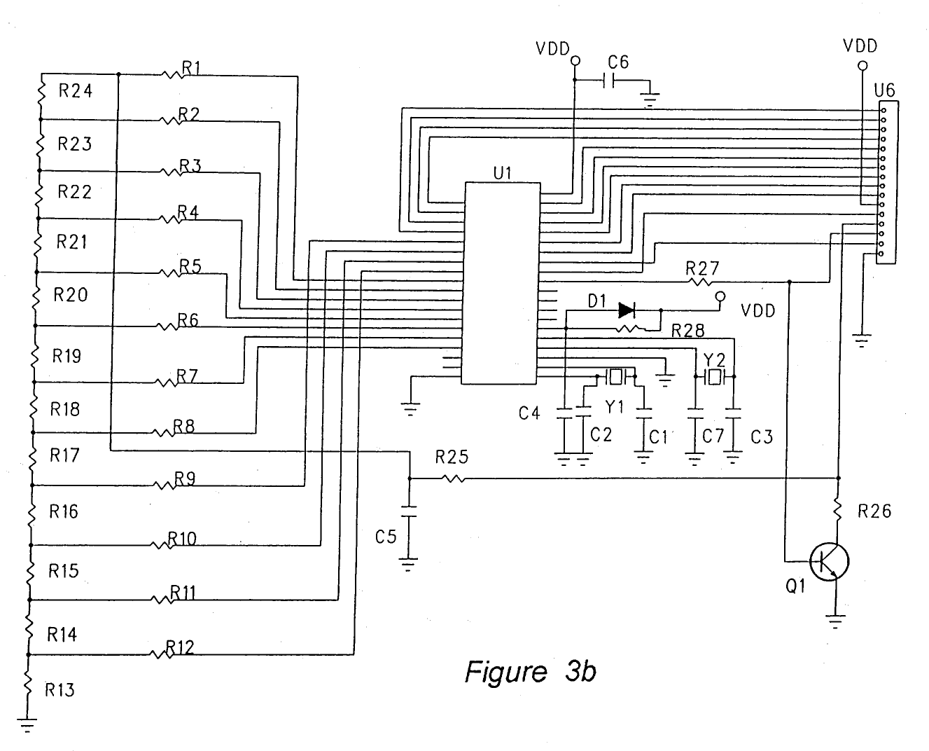

As seen in FIG. 2, one preferred embodiment of a transmitter circuit incorporates two data switches, an application-specific integrated circuit (ASIC), a voltage regulator and an antenna (ANTI). The data switches electrically correspond to the first main button (S1 or 5 in FIG. 1c) and the second LED discreet button (S2 or 3 in FIG. 1c). With the assistance of the application-specific integrated circuit (ASIC), each button (S1 or 5, S2 or 3) is stored with a pre-determined data format. The first main button (S1 or 5) is meant to be used by a visitor. It is stored with a first data format. When it is pressed, it will send the first data format through radio frequency signal to a receiver. The receiver will match the data format with those settings programmed in a databank (U2 in FIG. 3a). A pre-determined chime will be sounded. The discreet button (S2 or 3) is camouflaged by a LED light guide or any other camouflaging means. Only a member will be informed of this discreet feature. The discreet button (S2 or 3) is stored with a different data format. When it is pressed, it will send a second data format through radio frequency signal to the receiver. A different pre-determined chime will be sounded. Two chimes corresponding to the first and second data formats are employed to differentiate a visitor or a member. According to the teaching of the invention, these two chimes are predefined and preset at the receiver. This is commonly described as a scrolling feature of the invention at the receiver. Furthermore, the two chimes preset at the receiver can correspond commonly to transmission data formats from various transmitters (10) in the system.

The data format includes at least a channel code, an identification code, an original equipment manufacturer code, a product code and a battery status code. A microprocessor (U1 in FIG. 3b) is employed to distinguish these codes. The identification code is a unique code to identify every individual transmitter (10), such as its location in a building. Since the identification code is preset at factory, this will ensure that there will be no interference from neighbouring transmitters accidentally built with the same code. A user does not need to set or match channels on the receiver and transmitter units to avoid possible interference. The product code is used to identify the type of product, such as a doorbell, a motion detector or a contact transmitter, to the receiver unit. When activated, the battery status code will indicate a warning that the battery is running low and needs replacement.

It is also important to note that the transmitter (10) is battery-operated. The transmission data format of the transmitter circuit incorporates a warning status. Upon detecting this warning status, the receiver circuit will react in a predefined manner. This can be indicated by a specific chime from the receiver unit, which notifies a resident user to replace the batteries of the transmitter (10).

As seen in FIGS. 3a and 3b, one preferred embodiment of a receiver circuit incorporates a radio frequency (RF) controller, an audio amplifier (U3), a microprocessor (U1), a databank (U2) of chimes, and a speaker (SP1).

The microprocessor (U1) is the brain behind the receiver circuit diagram. When a programme button (S2) is pressed, the microprocessor (U1) is set in a programming mode. The receiver circuit is now waiting to receive a transmission data format for storage. The RF controller is connected to a main receiver motherboard via a RF module (J3). The transmitter data format is then received and sent through pin 3 of the RF module (J3). The data format is then amplified by a transistor (Q4) and routed to the microprocessor (U1). The received data format is analysed for validity of signal. If the signal is invalid, the data format is ignored and the microprocessor (U1) waits for another stream of signal data. If the signal is valid, then the microprocessor (U1) stores the data format into an electrically erasable programmable read only memory (EEPROM) or the databank (U2). A chime to be associated with the transmission data format is then selected via a sound button (S1) and linked to the transmission data format previously stored in the databank (U2). Different transmission data formats from various transmitters are subsequently programmed and stored in respective locations or addresses in the databank (U2).

On standby mode, the microprocessor (U1) pulses the RF controller by sending a low duty cycle pulse rate to the base of a transistor (Q5). The transistor (Q5) acts as a supply gate which, in turn, controls the supply to the RF controller. During active mode, the microprocessor (U1) waits for transmission data format from the RF controller.

If there is no data format detected during a pre-determined time period, the microprocessor (U1) cuts off the supply to the RF controller for a short duration before turning it on again. When a data format is detected, the microprocessor (U1) checks for validity of the code. If the data format is not valid, the rest of the stream of data is ignored and the microprocessor (U1) waits for another transmission. Next stream of data will start with preamble bits, which the microprocessor (U1) will use as clock synchronisation for it to decode the rest of the data stream effectively. When the data format is validated, the microprocessor (U1) will make references to the stored locations or addresses in the databank (U2), for a valid recognised identity previously programmed. If it is a recognised identity, the sound associated to this identity will be played by the microprocessor (U1). Prior to delivering the audio signal, the microprocessor (U1) activates the audio amplifier (U3), by switching on transistors (Q3 and Q2) which allow power supply to the audio amplifier (U3). The sound from the microprocessor (U1) is then amplified by the audio amplifier (U3) which drives a speaker (SP1). A LED (D3) is an indicator to denote the mode the receiver unit is in.

The invention has been described in an illustrative manner. It is to be understood that modifications and variations may be made in the light of the above teaching. For example, there are several possible arrangements with the transmitters and the receivers. One arrangement can be a plurality of transmitters in wireless communication with one common receiver. Another arrangement can be a plurality of transmitters in wireless communication with a plurality of receivers. For another example, the discreet button has been described as a LED button. Other camouflaged means can also be used.

Within the scope of the appended claims, the invention may be practiced otherwise than as specifically described above.

What is claimed is:

1. A security and alerting system, comprising;
at least one transmitter operable by an application-specific integrated circuit (ASIC) assisted transmitter circuit in wireless communication with at least one receiver operable by a microprocessor-assisted receiver circuit,
each transmitter being operable with at least two buttons, wherein a first main push button is used by a visitor, and at least a second button is camouflaged as a discreet button and is used discreetly by a member, such that the receiver will chime differently, thus allowing the residents within the hearing range to distinguish between the visitor and the member.

2. A transmitter in a wireless security and alerting system with at least one discreet button for identification as in claim 1, wherein the discreet button is an LED.

3. A transmitter in a wireless security and alerting system with at least one discreet button for identification as in claim 1, wherein the discreet button takes the form of other camouflaged means.

4. A transmitter in a wireless security and alerting system with at least one discreet button for identification as in claim 1, wherein the transmitter is battery-operated and the transmitter circuit incorporates a warning signal for low battery status.

5. A transmitter in a wireless security and alerting system with at least one discreet button for identification as in claim 1, wherein the transmitter activates at least two chimes preset at the receiver unit, wherein one is for visitors and the other for members.

6. A transmitter in a wireless security and alerting system with at least one discreet button for identification as in claim 5, wherein the chimes preset at the receiver can correspond commonly to transmission data formats from various transmitters in the system.
